(19) United States
(12) Patent Application Publication
(10) Pub. No.: US 2025/0217182 A1
(43) Pub. Date: Jul. 3, 2025

(54) INTERRUPT INFORMATION PROCESSING METHOD AND APPARATUS, DEVICE, AND STORAGE MEDIUM

(71) Applicant: Beijing Volcano Engine Technology Co., Ltd., Beijing (CN)

(72) Inventor: Zhimin FENG, Beijing (CN)

(21) Appl. No.: 18/906,499

(22) Filed: Oct. 4, 2024

(30) Foreign Application Priority Data
Jan. 3, 2024 (CN) 202410008667.X

(51) Int. Cl. G06F 9/48; G06F 9/30; G06F 9/455

(52) U.S. Cl. CPC G06F 9/4837; G06F 9/30189; G06F 9/45533

(57) ABSTRACT

An interrupt information processing method and apparatus, a device, and a storage medium. The method includes: determining a target VCPU process corresponding to a timer setting instruction in response to receiving the timer setting instruction, and obtaining, through a virtual machine corresponding to the target VCPU process, a timer interrupt identifier corresponding to the target VCPU process; modifying, through the virtual machine, indication information corresponding to the timer interrupt identifier to preset indication information, the indication information indicating whether the target VCPU process can receive timer interrupt information in a virtualization mode, and the preset indication information indicating that the target VCPU process can receive the timer interrupt information in the virtualization mode; and injecting, through an interrupt injection module, the timer interrupt information into the target VCPU process in the virtualization mode in response to that set time corresponding to the timer setting instruction is up.

### CROSS-REFERENCE TO RELATED APPLICATION

This application claims priority to Chinese Patent Application No. 202410008667.X, filed on Jan. 3, 2024, which is hereby incorporated by reference in its entirety.

### TECHNICAL FIELD

Embodiments of the present disclosure relate to the field of virtual machine technologies, and in particular, to an interrupt information processing method and apparatus, a device, and a storage medium.

### BACKGROUND

To improve resource utilization of a CPU (Central Processing Unit), a plurality of virtual machines are provided in the CPU, and each virtual machine may independently process a process. Timers are widely used in various operation scenarios of the virtual machines, and a scheduler of a CPU operating system uses the timers to realize that respective processes occupy resources of the virtual machines in turn according to a certain time period.

Currently, a timer of a virtual machine is processed by a VMM (Virtual Machine Manager). When a timer needs to be set for the virtual machine, the virtual machine exits from a virtualization mode to a host mode, and the VMM virtually creates a timer. Then, the virtual machine enters the virtualization mode from the host mode to continue to process a task process. After the set timer expires, the virtual machine exits from the virtualization mode to the host mode again, and the VMM injects a timer interrupt into the virtual machine, so that the virtual machine pauses the current task process, and processes a task process corresponding to the timer.

However, the inventor has found that the prior art has at least the following technical problems: to virtually create the timer through the VMM, the virtual machine needs to switch between the host mode and the virtualization mode multiple times, resulting in high consumption of the virtual machine, and thus reducing processing efficiency of the virtual machine.

### SUMMARY

Embodiments of the present disclosure provide an interrupt information processing method and apparatus, a device, and a storage medium, which can reduce consumption of a VCPU (virtual central processing unit) process and improve processing efficiency of a virtual machine. According to a first aspect, an embodiment of the present disclosure provides an interrupt information processing method, applied to a central processing unit (CPU), where the CPU includes an interrupt injection module and at least one physical central processing unit (PCPU), and the PCPU is configured to run a virtual central processing unit (VCPU) process on a virtual machine. The method includes:
determining a target VCPU process corresponding to a timer setting instruction in response to receiving the timer setting instruction, and obtaining, through a virtual machine corresponding to the target VCPU process, a timer interrupt identifier corresponding to the target VCPU process;
modifying, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode; and
injecting, through the interrupt injection module, the timer interrupt information into the target VCPU process in the virtualization mode in response to that set time corresponding to the timer setting instruction is up.

According to a second aspect, an embodiment of the present disclosure provides an interrupt information processing apparatus, applied to a central processing unit (CPU), where the CPU includes an interrupt injection module and at least one physical central processing unit (PCPU), and the PCPU is configured to run a virtual central processing unit (VCPU) process on a virtual machine. The apparatus includes:
an obtaining module, configured to determine a target VCPU process corresponding to a timer setting instruction in response to receiving the timer setting instruction, and obtain, through a virtual machine corresponding to the target VCPU process, a timer interrupt identifier corresponding to the target VCPU process;
a modifying module, configured to modify, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode; and
a processing module, configured to inject, through the interrupt injection module, the timer interrupt information into the target VCPU process in the virtualization mode in response to that set time corresponding to the timer setting instruction is up.

According to a third aspect, an embodiment of the present disclosure provides an electronic device, including:
a processor, and a memory communicatively connected to the processor;
where the memory stores computer-execution instructions; and
the processor executes the computer-execution instructions stored in the memory, to implement the interrupt information processing method according to the above first aspect.

According to a fourth aspect, an embodiment of the present disclosure provides a computer-readable storage medium, where the computer-readable storage medium stores computer-execution instructions, and when a processor executes the computer-execution instructions, the interrupt information processing method according to the above first aspect is implemented.

According to a fifth aspect, an embodiment of the present disclosure provides a computer program product, including a computer program, and when the computer program is executed by a processor, the interrupt information processing method according to the above first aspect is implemented.

The interrupt information processing method and apparatus, the device, and the storage medium are provided in the embodiments. The method includes: determining a target VCPU process corresponding to a timer setting instruction in response to receiving the timer setting instruction, and obtaining, through a virtual machine corresponding to the target VCPU process, a timer interrupt identifier corresponding to the target VCPU process; modifying, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode; and injecting, through the interrupt injection module, the timer interrupt information into the target VCPU process in the virtualization mode in response to that set time corresponding to the timer setting instruction is up. In the embodiments of the present application, before the set time corresponding to the timer setting instruction is up, the indication information corresponding to the timer interrupt identifier is modified to the preset indication information. In this way, when the set time corresponding to the timer setting instruction is up, the timer interrupt can be directly injected into the target VCPU process in the virtualization mode through the interrupt injection module. Therefore, the virtual machine does not need to switch from the virtualization mode to a host mode, thereby reducing consumption of the VCPU process and improving processing efficiency of the virtual machine.

### BRIEF DESCRIPTION OF DRAWINGS

In order to more clearly describe the technical solutions in the embodiments of the present disclosure or in the prior art, the following briefly describes the accompanying drawings required for describing the embodiments or the prior art. Apparently, the accompanying drawings in the following description show some embodiments of the present disclosure, and persons of ordinary skill in the art may still derive other drawings from these accompanying drawings without creative efforts.

FIG. 1 is a schematic diagram of an application scenario of an interrupt information processing method according to an embodiment of the present disclosure.

FIG. 2 is a flowchart of an interrupt information processing method according to an embodiment of the present disclosure.

FIG. 3 is a schematic diagram of an interrupt information processing method according to an embodiment of the present disclosure.

FIG. 4 is a flowchart of another interrupt information processing method according to an embodiment of the present disclosure.

FIG. 5 is a structural block diagram of an interrupt information processing apparatus according to an embodiment of the present disclosure.

FIG. 6 is a schematic diagram of a hardware structure of an electronic device according to an embodiment of the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by persons of ordinary skill in the art based on the embodiments of the present disclosure without creative efforts shall fall within the protection scope of the present disclosure.

It should be noted that user information (including but not limited to user device information and user personal information) and data (including but not limited to data for analysis, stored data, and displayed data) involved in the present application are information and data authorized by users or fully authorized by all parties. In addition, the collection, use, and processing of the related data need to comply with relevant laws, regulations, and standards, and corresponding operation entrances are provided for users to select to authorize or refuse.

To improve resource utilization of a CPU (Central Processing Unit), a plurality of virtual machines are provided within the CPU, and each virtual machine may independently process a process. Timers are widely used in various operation scenarios of the virtual machines, for example, a scenario of implementing a timed task or a periodic task. A scheduler of a CPU operating system uses the timers to realize that respective processes occupy resources of the virtual machines in turn according to a certain time period.

Currently, a timer of a virtual machine is processed by a VMM (Virtual Machine Manager). When a timer needs to be set for the virtual machine, the virtual machine exits from a virtualization mode (i.e., a guest mode) to a host mode (i.e., a host mode), and the VMM virtually creates a timer. Then, the virtual machine enters the virtualization mode from the host mode to continue to process a task process. After the set timer expires, the virtual machine exits from the virtualization mode to the host mode again, and the VMM injects a timer interrupt into the virtual machine, so that the virtual machine pauses the current task process, and processes a task process corresponding to the timer. It should be noted that a system permission corresponding to the host mode is higher, and a system permission corresponding to the virtualization mode is lower. Therefore, for system security, the task process is run in the virtualization mode. When the task process needs to obtain information with higher permission, the virtual machine where the task process is located needs to exit from the virtualization mode to the host mode.

However, currently, overheads of emulating a timer in virtualization are relatively high. When setting one timer for the virtual machine, and when the timer expires, the virtual machine needs to exit from the virtualization mode to the host mode. In other words, the virtual machine needs to exit twice (the first exit is to set the timer, and the second exit is for interrupt injection after the timer expires).

It can be seen that to virtually create the timer through the VMM, the virtual machine needs to switch between the host mode and the virtualization mode multiple times, resulting in high consumption of a VCPU (Virtual Central Processing Unit) process, and thus reducing processing efficiency of the virtual machine.

Therefore, how to reduce the consumption of the VCPU process and improve the processing efficiency of the virtual machine is an urgent problem to be solved.

In the related art, a module may be installed within the virtual machine. The module writes a timer, which needs to be set, into a share memory according to a certain format. Then, a polling process is created on the CPU, and is responsible for constantly polling the share memory of the virtual machine. When a new timer is set within the virtual machine, the polling process reads timer information of the virtual machine, and starts one timer. After the timer expires, the polling process injects a timer interrupt into the virtual machine. Because the CPU can obtain the timer information of the virtual machine from the share memory through the created polling process, it is not necessary for the virtual machine to switch between the host mode and the virtualization mode multiple times.

However, the disadvantage of the foregoing technology is that CPU resources need to be reserved on a host to poll the timer information of the virtual machine, thereby causing a certain loss of CPU resources.

Further, to solve the foregoing problems, a virtual machine running in the virtualization mode is enabled to directly receive timer interrupt information without increasing the loss of CPU resources, and the virtual machine does not need to switch between the host mode and the virtualization mode.

The embodiments provide the following technical concept. When a virtual machine runs in the virtualization mode, and a piece of specific interrupt information needs to be injected into a VCPU process in the virtual machine, it is only necessary to modify indication information corresponding to a timer interrupt of the VCPU process to preset indication information (for example, set to 1). In this case, the interrupt information can be injected into the VCPU process in the virtualization mode, and the virtual machine will not be caused to exit from the virtualization mode. Correspondingly, specific steps may include: first, determining a target VCPU process corresponding to a timer setting instruction in response to receiving the timer setting instruction, and obtaining, through a virtual machine corresponding to the target VCPU process, a timer interrupt identifier corresponding to the target VCPU process; second, modifying, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode; and finally, injecting, through an interrupt injection module, the timer interrupt information into the target VCPU process in the virtualization mode in response to that set time corresponding to the timer setting instruction is up. In this case, before the set time corresponding to the timer setting instruction is up, the indication information corresponding to the timer interrupt identifier is modified to the preset indication information. In this way, when the set time corresponding to the timer setting instruction is up, the timer interrupt can be directly injected into the target VCPU process in a client mode (virtualization mode) through the interrupt injection module. Therefore, the virtual machine does not need to switch from the client mode to a host mode, thereby reducing consumption of the VCPU process and improving processing efficiency of the virtual machine.

It should be noted that in a DPU (Data Processing Unit) scenario, many processes on a CPU are offloaded to a DPU for processing, so that the CPU does not need to reserve a specific PCPU to process processes on the CPU, thereby improving processing efficiency of the CPU. In the embodiments of the present disclosure, because the virtual machine does not need to switch from the client mode to the host mode, the consumption of the VCPU process is reduced, and the processing efficiency of the virtual machine is improved. At the same time, the processing efficiency of the CPU is further improved.

The following provides an explanation of an application scenario of the embodiments of the present disclosure.

The interrupt information processing method provided in the embodiments of the present disclosure may be applied to various operation scenarios of a virtual machine, for example, a scenario of implementing a timed task or a periodic task. FIG. 1 is a schematic diagram of an application scenario of an interrupt information processing method according to an embodiment of the present disclosure. As shown in FIG. 1, three task processes are run within a CPU, and are respectively process A, process B, and a VCPU process on a virtual machine. For example, a timer may be set for the VCPU process (a timed task) through the method in the present application. Before the timer of the VCPU process expires, a task processed by the CPU is the process A. When the timer of the VCPU process expires, the CPU pauses processing the process A, and processes the VCPU process. After the VCPU process is processed, processing for the process A is continued.

In the following, detailed embodiments are used to describe in detail the interrupt information processing method provided in the embodiments of the present disclosure.

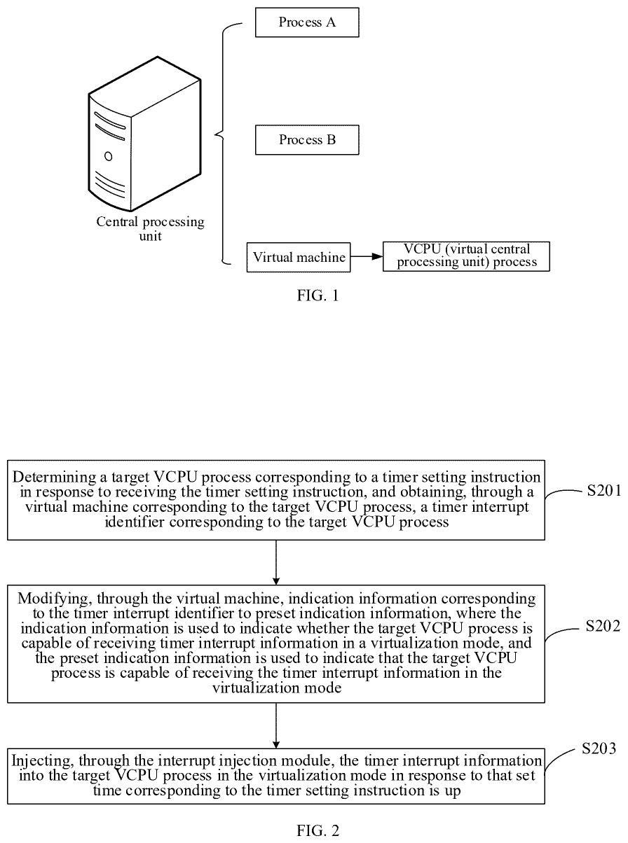

FIG. 2 is a flowchart of an interrupt information processing method according to an embodiment of the present disclosure. An execution subject of the interrupt information processing method may be a central processing unit (CPU), where the CPU includes an interrupt injection module and at least one physical central processing unit (PCPU), and the PCPU is configured to run a VCPU process on a virtual machine. As shown in FIG. 2, the method includes the following steps.

S201: determining a target VCPU process corresponding to a timer setting instruction in response to receiving the timer setting instruction, and obtaining, through a virtual machine corresponding to the target VCPU process, a timer interrupt identifier corresponding to the target VCPU process.

In the embodiments of the present application, a task list is created within the virtual machine, and the task list includes a plurality of processes. The plurality of processes include VCPU processes and other processes (for example, a disk process, a memory process, etc.).

In an implementation, obtaining, through the virtual machine, the timer interrupt identifier corresponding to the target VCPU process may include the following steps (a) to (c).
(a) Obtaining, through the virtual machine corresponding to the target VCPU process, attribute information respectively corresponding to at least one VCPU process within the virtual machine, where the attribute information includes interrupt identifiers respectively corresponding to a plurality of interrupt types.

In some embodiments, each VCPU process corresponds to one piece of attribute information, and the attribute information of each VCPU process may be uploaded to the virtual machine, so that the virtual machine can modify the attribute information of the VCPU process in the virtualization mode. Exemplarily, the attribute information corresponding to the VCPU process may be represented as: pi_desc. The plurality of interrupt types include a timer interrupt, a disk interrupt, and the like.
(b) Selecting, through the virtual machine, target attribute information corresponding to the target VCPU process from the attribute information respectively corresponding to the at least one VCPU process according to a process identifier corresponding to the target VCPU process.

In an implementation, one process corresponds to one process identifier, and the process identifier may be a process name, a process code, or the like. For example, the process identifiers may be: VCPU1, VCPU2, VCPU3, and the like.

In some embodiments, the process identifier corresponding to the target VCPU process is: VCPU1, and target attribute information corresponding to VCPU1 is selected from the attribute information respectively corresponding to the at least one VCPU process.
(c) Selecting, through the virtual machine, the timer interrupt identifier corresponding to the target VCPU process from the interrupt identifiers respectively corresponding to the plurality of interrupt types included in the target attribute information.

In some embodiments, the interrupt identifier is an interrupt number. The target attribute information may include 256 interrupt types, and each interrupt type corresponds to one interrupt number. The interrupt number may be represented by a pir value. Exemplarily, the timer interrupt number is: pir=236.

S202: modifying, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode.

In some embodiments, the indication information corresponding to the timer interrupt identifier may be encoded information corresponding to the timer interrupt identifier. In an implementation, the encoded information corresponding to the timer interrupt identifier is “pir-236”. The preset indication information may be “1”, and indicates that the target VCPU process is capable of receiving the timer interrupt information in the virtualization mode. It should be noted that when the indication information corresponding to the timer interrupt identifier is “0”, it indicates that the target VCPU process cannot receive the timer interrupt information in the virtualization mode.

In an implementation, the indication information corresponding to the timer interrupt identifier may be modified to the preset indication information through a hook operation. Correspondingly, before modifying, through the virtual machine, the indication information corresponding to the timer interrupt identifier to the preset indication information, the method may further include: performing a hook operation on a preset program within the virtual machine, where the hook operation is used to modify the indication information corresponding to the timer interrupt identifier to the preset indication information when the timer setting instruction is received.

In an implementation, the preset program is a set next event function.

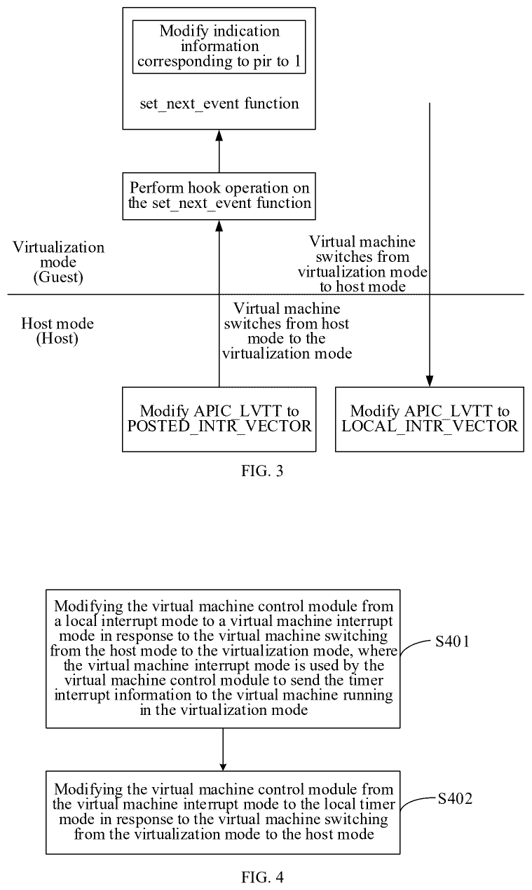

For example, as shown in FIG. 3, the interrupt number may be represented by a pir value. In this case, a hook operation may be performed on the set_next_event function within the virtual machine. Each time when setting a new timer, the indication information corresponding to the timer interrupt identifier (pir=236 in pi_desc) may be modified to 1, and a timer setting operation is completed.

S203: injecting, through the interrupt injection module, the timer interrupt information into the target VCPU process in the virtualization mode in response to that set time corresponding to the timer setting instruction is up.

In the embodiments of the present disclosure, a value of the set time is not specifically limited. In an implementation, the set time may be 10 milliseconds, 100 milliseconds, or the like.

In an implementation, this step may be: in response to that the set time corresponding to the timer setting instruction is up, the timer may send the timer interrupt information to the CPU where the virtual machine is located, and the CPU injects the timer interrupt information into the target VCPU process of the virtual machine through the interrupt injection module.

The virtual machine runs in the virtualization mode, and does not need to switch from a client mode to a host mode.

The embodiments of the present disclosure provide the interrupt information processing method, including: determining the target VCPU process corresponding to the timer setting instruction in response to receiving the timer setting instruction, and obtaining, through the virtual machine corresponding to the target VCPU process, the timer interrupt identifier corresponding to the target VCPU process; modifying, through the virtual machine, the indication information corresponding to the timer interrupt identifier to the preset indication information, where the indication information is used to indicate whether the target VCPU process is capable of receiving the timer interrupt information in the virtualization mode, and the preset indication information is used to indicate that the target VCPU process is capable of receiving the timer interrupt information in the virtualization mode; and injecting, through the interrupt injection module, the timer interrupt information into the target VCPU process in the virtualization mode in response to that the set time corresponding to the timer setting instruction is up. In the embodiments of the present application, before the set time corresponding to the timer setting instruction is up, the indication information corresponding to the timer interrupt identifier is modified to the preset indication information. In this way, when the set time corresponding to the timer setting instruction is up, the timer interrupt can be directly injected into the target VCPU process in the client mode through the interrupt injection module. Therefore, the virtual machine does not need to switch from the client mode to the host mode, thereby reducing consumption of the VCPU process and improving processing efficiency of the virtual machine.

In the embodiments of the present application, as shown in FIG. 3, the CPU further includes a virtual machine control module. When a mode of the virtual machine is switched, a parameter within the virtual machine control module may be modified, so as to realize that the CPU can inject the timer interrupt information into the target VCPU process of the virtual machine through the interrupt injection module. In other words, adjustment needs to be separately performed on a host side and a virtual machine (Guest) side.

FIG. 4 is a flowchart of an interrupt information processing method according to an embodiment of the present disclosure. As shown in FIG. 4, steps of performing adjustment on the host side include the following steps.

S401: modifying the virtual machine control module from a local timer mode to a virtual machine interrupt mode in response to the virtual machine switching from the host mode to the virtualization mode, where the virtual machine interrupt mode is used by the virtual machine control module to send the timer interrupt information to the virtual machine running in the virtualization mode.

In an implementation, as shown in FIG. 3, the virtual machine control module may be represented as APIC_LVTT. The local timer mode may be represented as LOCAL_TIMER_VECTOR, and the virtual machine interrupt mode may be represented as POSTED_INTR_VECTOR.

In response to the virtual machine switching from the host mode to the virtualization mode, APIC_LVTT is modified to: “POSTED_INTR_VECTOR”. In this way, the CPU can trigger expiration of the timer in the virtualization mode, and one piece of POSTED_INTR_VECTOR interrupt information can be generated through the virtual machine control module. The POSTED_INTR_VECTOR interrupt information can be directly sent to the virtual machine running in the virtualization mode, without causing the virtual machine to exit the virtualization mode.

S402: modifying the virtual machine control module from the virtual machine interrupt mode to the local timer mode in response to the virtual machine switching from the virtualization mode to the host mode.

It should be noted that after the virtual machine completes the timer task, the virtual machine may switch from the virtualization mode to the host mode. In this case, the parameter of the virtual machine control module also needs to be reset.

Exemplarily, when the virtual machine switches from the virtualization mode to the host mode, APIC_LVTT is modified to: “LOCAL_TIMER_VECTOR”, so that normal trigger of a timer task on the host can be ensured.

It should be noted that other interrupt information except the timer interrupt information may also trigger the interrupt injection module to inject the timer interrupt information into the virtual machine, resulting in that the virtual machine receives invalid timer interrupt information, thereby affecting performance of the virtual machine.

In some embodiments, to avoid an impact of the invalid timer interrupt information on the virtual machine, before step 201, the method further includes:
obtaining a first quantity of timer interrupt information received by the virtual machine within a preset duration and a second quantity of other interrupt information, except the timer interrupt information, received by the virtual machine within the preset duration; and
if the first quantity is greater than the second quantity, performing step 201; if the first quantity is not greater than the second quantity, not performing step 201.

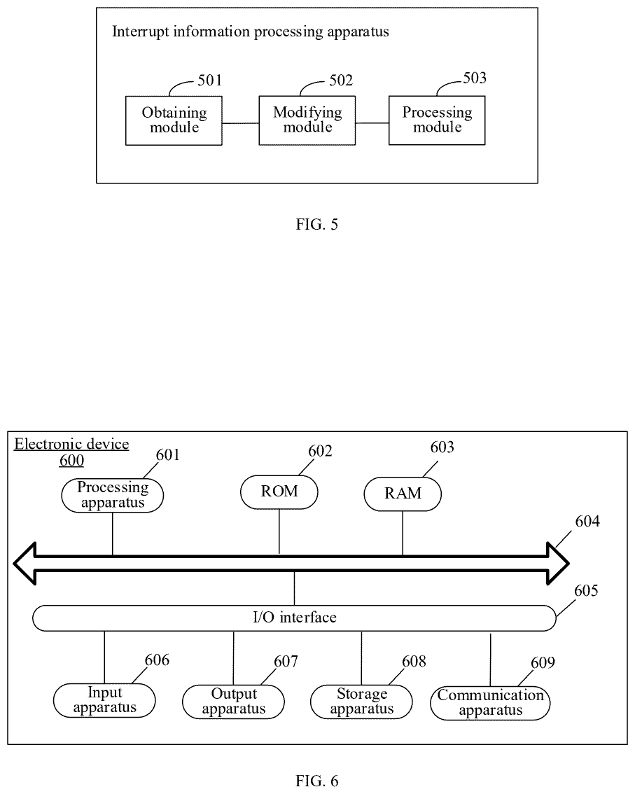

FIG. 5 is a structural block diagram of an interrupt information processing apparatus according to an embodiment of the present disclosure. The processing apparatus is applied to a central processing unit (CPU), where the CPU includes an interrupt injection module and at least one physical central processing unit (PCPU), and the PCPU is configured to run a VCPU process on a virtual machine. As shown in FIG. 5, the apparatus includes: an obtaining module 501, a modifying module 502, and a processing module 503.

The obtaining module 501 is configured to determine a target VCPU process corresponding to a timer setting instruction in response to receiving the timer setting instruction, and obtain, through a virtual machine corresponding to the target VCPU process, a timer interrupt identifier corresponding to the target VCPU process.

The modifying module 502 is configured to modify, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode.

The processing module 503 is configured to inject, through the interrupt injection module, the timer interrupt information into the target VCPU process in the virtualization mode in response to that set time corresponding to the timer setting instruction is up.

According to one or more embodiments of the present disclosure, the obtaining module 501, when obtaining, through the virtual machine corresponding to the target VCPU process, the timer interrupt identifier corresponding to the target VCPU process, is specifically configured to: obtain, through the virtual machine corresponding to the target VCPU process, attribute information respectively corresponding to at least one VCPU process within the virtual machine, where the attribute information includes interrupt identifiers respectively corresponding to a plurality of interrupt types; select, through the virtual machine, target attribute information corresponding to the target VCPU process from the attribute information respectively corresponding to the at least one VCPU process according to a process identifier corresponding to the target VCPU process; and select, through the virtual machine, the timer interrupt identifier corresponding to the target VCPU process from the interrupt identifiers respectively corresponding to the plurality of interrupt types included in the target attribute information.

According to one or more embodiments of the present disclosure, the apparatus further includes a setting module, where the setting module is configured to perform a hook operation on a preset program within the virtual machine, where the hook operation is used to modify the indication information corresponding to the timer interrupt identifier to the preset indication information when the timer setting instruction is received.

According to one or more embodiments of the present disclosure, the preset program is a set next event function.

According to one or more embodiments of the present disclosure, the CPU further includes a virtual machine control module; correspondingly, the apparatus further includes: an adjusting module, configured to modify the virtual machine control module from a local timer mode to a virtual machine interrupt mode in response to the virtual machine switching from a host mode to the virtualization mode, where the virtual machine interrupt mode is used by the virtual machine control module to send the timer interrupt information to the virtual machine running in the virtualization mode.

According to one or more embodiments of the present disclosure, the adjusting module is further configured to modify the virtual machine control module from the virtual machine interrupt mode to the local timer mode in response to the virtual machine switching from the virtualization mode to the host mode.

According to one or more embodiments of the present disclosure, the apparatus further includes a condition determining module, where the condition determining module is configured to: obtain a first quantity of timer interrupt information received by the virtual machine within a preset duration and a second quantity of other interrupt information, except the timer interrupt information, received by the virtual machine within the preset duration; and if the first quantity is greater than the second quantity, perform the step of determining the target VCPU process corresponding to the timer setting instruction in response to receiving the timer setting instruction, and obtaining, through the virtual machine corresponding to the target VCPU process, the timer interrupt identifier corresponding to the target VCPU process.

The obtaining module 501, the modifying module 502, and the processing module 503 are connected in sequence. The interrupt information processing apparatus provided in this embodiment can execute the technical solutions of the above method embodiments. The implementation principles and technical effects thereof are similar, and are not described here again in this embodiment.

FIG. 6 is a schematic diagram of a hardware structure of an electronic device according to an embodiment of the present disclosure. With reference to FIG. 6, an electronic device 600 may be a terminal device or a server. The terminal device may include, but is not limited to, mobile terminals such as a mobile phone, a notebook computer, a digital broadcast receiver, a personal digital assistant (PDA), a tablet computer (Portable Android Device, PAD), a portable media player (PMP), a vehicle-mounted terminal (for example, a vehicle navigation terminal) and the like, and fixed terminals such as a digital TV, a desktop computer and the like. The electronic device shown in FIG. 6 is merely an example, and shall not impose any limitation on the functions and scope of use of the embodiments of the present disclosure.

As shown in FIG. 6, the electronic device 600 may include a processing apparatus (for example, a central processing unit, a graphics processor, or the like) 601 that may perform a variety of appropriate actions and processing in accordance with a program stored in a read only memory (ROM) 602 or a program loaded from a storage apparatus 608 to a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 609 and installed, or installed from the storage apparatus 608, or installed from the ROM 602. When the computer program is executed by the processing apparatus 601, the above-mentioned functions defined in the methods of the embodiments of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device, or the computer-readable medium may exist independently, without being assembled into the electronic device.

The above computer-readable medium carries one or more programs, and when the one or more programs are executed by the electronic device, the electronic device is enabled to execute the methods shown in the above embodiments.

The computer program code for performing the operations in the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate the architectures, functions, and operations of the possible implementations of the systems, the methods, and the computer program products according to various embodiments of the present disclosure. In this regard, each block in the flowcharts or block diagrams may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagrams and/or the flowcharts, and a combination of the blocks in the block diagrams and/or the flowcharts may be implemented by a dedicated hardware-based system that executes specified functions or operations, or may be implemented by a combination of dedicated hardware and computer instructions.

The units described in the embodiments of the present disclosure may be implemented by software, or may be implemented by hardware. The name of a unit does not constitute a limitation on the unit itself in some cases. For example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, the machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read only memory (ROM), an erasable programmable read-only memory (EPROM or flash memory), an optic fiber, a portable compact disk read-only memory (CD-ROM), an optical storage device, a magnetic storage device, or any suitable combination thereof.

In a first aspect, according to one or more embodiments of the present disclosure, there is provided an interrupt information processing method, applied to a central processing unit (CPU), where the CPU includes an interrupt injection module and at least one physical central processing unit (PCPU), and the PCPU is configured to run a VCPU process on a virtual machine. The method includes:
determining a target VCPU process corresponding to a timer setting instruction in response to receiving the timer setting instruction, and obtaining, through a virtual machine corresponding to the target VCPU process, a timer interrupt identifier corresponding to the target VCPU process;
modifying, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode; and
injecting, through the interrupt injection module, the timer interrupt information into the target VCPU process in the virtualization mode in response to that set time corresponding to the timer setting instruction is up.

According to one or more embodiments of the present disclosure, the obtaining, through the virtual machine corresponding to the target VCPU process, the timer interrupt identifier corresponding to the target VCPU process includes: obtaining, through the virtual machine corresponding to the target VCPU process, attribute information respectively corresponding to at least one VCPU process within the virtual machine, where the attribute information includes interrupt identifiers respectively corresponding to a plurality of interrupt types; selecting, through the virtual machine, target attribute information corresponding to the target VCPU process from the attribute information respectively corresponding to the at least one VCPU process according to a process identifier corresponding to the target VCPU process; and selecting, through the virtual machine, the timer interrupt identifier corresponding to the target VCPU process from the interrupt identifiers respectively corresponding to the plurality of interrupt types included in the target attribute information.

According to one or more embodiments of the present disclosure, before modifying, through the virtual machine, the indication information corresponding to the timer interrupt identifier to preset indication information, the method further includes: performing a hook operation on a preset program within the virtual machine, where the hook operation is used to modify the indication information corresponding to the timer interrupt identifier to the preset indication information when the timer setting instruction is received.

According to one or more embodiments of the present disclosure, the preset program is a set next event function.

According to one or more embodiments of the present disclosure, the CPU is further provided with a virtual machine control module; correspondingly, before determining the target VCPU process corresponding to the timer setting instruction in response to receiving the timer setting instruction, and obtaining, through the virtual machine corresponding to the target VCPU process, the timer interrupt identifier corresponding to the target VCPU process, the method further includes: modifying the virtual machine control module from a local timer mode to a virtual machine interrupt mode in response to the virtual machine switching from a host mode to the virtualization mode, where the virtual machine interrupt mode is used by the virtual machine control module to send the timer interrupt information to the virtual machine running in the virtualization mode.

According to one or more embodiments of the present disclosure, the method further includes: modifying the virtual machine control module from the virtual machine interrupt mode to the local timer mode in response to the virtual machine switching from the virtualization mode to the host mode.

According to one or more embodiments of the present disclosure, before determining the target VCPU process corresponding to the timer setting instruction in response to receiving the timer setting instruction, and obtaining, through the virtual machine corresponding to the target VCPU process, the timer interrupt identifier corresponding to the target VCPU process, the method further includes: obtaining a first quantity of timer interrupt information received by the virtual machine within a preset duration and a second quantity of other interrupt information, except the timer interrupt information, received by the virtual machine within the preset duration; and if the first quantity is greater than the second quantity, performing the step of determining the target VCPU process corresponding to the timer setting instruction in response to receiving the timer setting instruction, and obtaining, through the virtual machine corresponding to the target VCPU process, the timer interrupt identifier corresponding to the target VCPU process.

In a second aspect, according to one or more embodiments of the present disclosure, there is provided an interrupt information processing apparatus, applied to a central processing unit (CPU), where the CPU includes an interrupt injection module and at least one physical central processing unit (PCPU), and the PCPU is configured to run a VCPU process on a virtual machine. The apparatus includes:
an obtaining module, configured to determine a target VCPU process corresponding to a timer setting instruction in response to receiving the timer setting instruction, and obtain, through a virtual machine corresponding to the target VCPU process, a timer interrupt identifier corresponding to the target VCPU process;
a modifying module, configured to modify, through the virtual machine, indication information corresponding to the timer interrupt identifier to preset indication information, where the indication information is used to indicate whether the target VCPU process is capable of receiving timer interrupt information in a virtualization mode, and the preset indication information is used to indicate that the target VCPU process is capable of receiving the timer interrupt information in the virtualization mode; and
a processing module, configured to inject, through the interrupt injection module, the timer interrupt information into the target VCPU process in the virtualization mode in response to that set time corresponding to the timer setting instruction is up.

According to one or more embodiments of the present disclosure, the obtaining module, when obtaining the timer interrupt identifier corresponding to the target VCPU process through the virtual machine corresponding to the target VCPU process, is specifically configured to: obtain, through the virtual machine corresponding to the target VCPU process, attribute information respectively corresponding to at least one VCPU process within the virtual machine, where the attribute information includes interrupt identifiers respectively corresponding to a plurality of interrupt types; select, through the virtual machine, target attribute information corresponding to the target VCPU process from the attribute information respectively corresponding to the at least one VCPU process according to a process identifier corresponding to the target VCPU process; and select, through the virtual machine, the timer interrupt identifier corresponding to the target VCPU process from the interrupt identifiers respectively corresponding to the plurality of interrupt types included in the target attribute information.

According to one or more embodiments of the present disclosure, the apparatus further includes: a setting module, where the setting module is configured to perform a hook operation on a preset program within the virtual machine, where the hook operation is used to modify the indication information corresponding to the timer interrupt identifier to the preset indication information when the timer setting instruction is received.

According to one or more embodiments of the present disclosure, the preset program is a set next event function.

According to one or more embodiments of the present disclosure, the CPU is further provided with a virtual machine control module; correspondingly, the apparatus further includes: an adjusting module, configured to modify the virtual machine control module from a local timer mode to a virtual machine interrupt mode in response to the virtual machine switching from a host mode to the virtualization mode, where the virtual machine interrupt mode is used by the virtual machine control module to send the timer interrupt information to the virtual machine running in the virtualization mode.

According to one or more embodiments of the present disclosure, the adjusting module is further configured to modify the virtual machine control module from the virtual machine interrupt mode to the local timer mode in response to the virtual machine switching from the virtualization mode to the host mode.

According to one or more embodiments of the present disclosure, the apparatus further includes a condition determining module, where the condition determining module is configured to obtain a first quantity of timer interrupt information received by the virtual machine within a preset duration and a second quantity of other interrupt information, except the timer interrupt information, received by the virtual machine within the preset duration, and if the first quantity is greater than the second quantity, perform the step of determining the target VCPU process corresponding to the timer setting instruction in response to receiving the timer setting instruction, and obtaining, through the virtual machine corresponding to the target VCPU process, the timer interrupt identifier corresponding to the target VCPU process.

In a third aspect, according to one or more embodiments of the present disclosure, there is provided an electronic device, including: a processor, and a memory communicatively connected to the processor, where
the memory stores computer-execution instructions; and
the processor executes the computer-execution instructions stored in the memory, to implement the interrupt information processing method according to the first aspect and the various possible designs of the first aspect described above.

In a fourth aspect, according to one or more embodiments of the present disclosure, there is provided a computer-readable storage medium storing computer-execution instructions, and when the computer-execution instructions are executed by a processor, implements the interrupt information processing method according to the first aspect and the various possible designs of the first aspect described above.

In a fifth aspect, an embodiment of the present disclosure provides a computer program product including a computer program, and when the computer program is executed by a processor, the interrupt information processing method according to the first aspect and the various possible designs of the first aspect described above is implemented.

The foregoing descriptions are merely preferred embodiments of the present disclosure and explanations of the applied technical principles. A person skilled in the art should understand that the scope of disclosure involved in the present disclosure is not limited to the technical solutions formed by specific combinations of the foregoing technical features, and shall also cover other technical solutions formed by any combination of the foregoing technical features or their equivalent features without departing from the foregoing concept of disclosure, for example, technical solutions formed by replacing the foregoing features with technical features with similar functions as disclosed in the present disclosure (but not limited thereto) with each other.

In addition, although the various operations are described in a specific order, it should not be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments may alternatively be implemented in combination in a single embodiment. In contrast, various features described in a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. An interrupt information processing method, applied to a central processing unit (CPU), wherein the CPU comprises at least one physical central processing unit (PCPU), and the PCPU is configured to run a virtual central processing unit (VCPU) process on a virtual machine; the method comprises:
determining a target VCPU process corresponding to a timer setting instruction in response to receiving the timer setting instruction, and obtaining, through a virtual machine corresponding to the target VCPU process, a timer interrupt identifier corresponding to the target VCPU process;
modifying, through the virtual machine, indication information corresponding to the timer interrupt identifier to preset indication information, wherein the indication information is used to indicate whether the target VCPU process is capable of receiving timer interrupt information in a virtualization mode, and the preset indication information is used to indicate that the target VCPU process is capable of receiving the timer interrupt information in the virtualization mode; and
injecting timer interrupt information into the target VCPU process in the virtualization mode in response to set time corresponding to the timer setting instruction is up.

2. The method according to claim 1, wherein the obtaining, through the virtual machine corresponding to the target VCPU process, the timer interrupt identifier corresponding to the target VCPU process comprises:
obtaining, through the virtual machine corresponding to the target VCPU process, attribute information respectively corresponding to at least one VCPU process within the virtual machine, wherein the attribute information comprises interrupt identifiers respectively corresponding to a plurality of interrupt types;
selecting, through the virtual machine, target attribute information corresponding to the target VCPU process from the attribute information respectively corresponding to the at least one VCPU process according to a process identifier corresponding to the target VCPU process; and
selecting, through the virtual machine, the timer interrupt identifier corresponding to the target VCPU process from the interrupt identifiers respectively corresponding to the plurality of interrupt types comprised in the target attribute information.

3. The method according to claim 1, wherein before modifying, through the virtual machine, the indication information corresponding to the timer interrupt identifier to the preset indication information, the method further comprises:
performing a hook operation on a preset program within the virtual machine, wherein the hook operation is used to modify the indication information corresponding to the timer interrupt identifier to the preset indication information when the timer setting instruction is received.

4. The method according to claim 3, wherein the preset program is a set next event function.

5. The method according to claim 1, wherein a virtual machine control mode is provided in the CPU;
correspondingly, before determining the target VCPU process corresponding to the timer setting instruction in response to receiving the timer setting instruction, and obtaining, through the virtual machine corresponding to the target VCPU process, the timer interrupt identifier corresponding to the target VCPU process, the method further comprises:
modifying the virtual machine control mode from a local timer mode to a virtual machine interrupt mode in response to the virtual machine switching from a host mode to the virtualization mode;
wherein the virtual machine interrupt mode is used by the CPU to send the timer interrupt information to the virtual machine running in the virtualization mode.

6. The method according to claim 5, wherein the method further comprises:
modifying the virtual machine control mode from the virtual machine interrupt mode to the local timer mode in response to the virtual machine switching from the virtualization mode to the host mode.

7. The method according to claim 1, wherein before determining the target VCPU process corresponding to the timer setting instruction in response to receiving the timer setting instruction, and obtaining, through the virtual machine corresponding to the target VCPU process, the timer interrupt identifier corresponding to the target VCPU process, the method further comprises:
obtaining a first quantity of timer interrupt information received by the virtual machine within a preset duration and a second quantity of other interrupt information, except the timer interrupt information, received by the virtual machine within the preset duration; and
if the first quantity is greater than the second quantity, performing the step of determining the target VCPU process corresponding to the timer setting instruction in response to receiving the timer setting instruction, and obtaining, through the virtual machine corresponding to the target VCPU process, the timer interrupt identifier corresponding to the target VCPU process.

8. An electronic device, comprising a central processing unit (CPU), wherein the CPU comprises at least one physical central processing unit (PCPU), and the PCPU is configured to run a virtual central processing unit (VCPU) process on a virtual machine; and the electronic device comprises a processor, and a memory communicatively connected to the processor;
wherein the memory stores computer-execution instructions; and
the processor is configured to execute the computer-execution instructions stored in the memory to:
determine a target VCPU process corresponding to a timer setting instruction in response to receiving the timer setting instruction, and obtain, through a virtual machine corresponding to the target VCPU process, a timer interrupt identifier corresponding to the target VCPU process;
modify, through the virtual machine, indication information corresponding to the timer interrupt identifier to preset indication information, wherein the indication information is used to indicate whether the target VCPU process is capable of receiving timer interrupt information in a virtualization mode, and the preset indication information is used to indicate that the target VCPU process is capable of receiving the timer interrupt information in the virtualization mode; and
inject the timer interrupt information into the target VCPU process in the virtualization mode in response to that set time corresponding to the timer setting instruction is up.

9. The electronic device according to claim 8, wherein the processor is configured to:
obtain, through the virtual machine corresponding to the target VCPU process, attribute information respectively corresponding to at least one VCPU process within the virtual machine, wherein the attribute information comprises interrupt identifiers respectively corresponding to a plurality of interrupt types;
select, through the virtual machine, target attribute information corresponding to the target VCPU process from the attribute information respectively corresponding to the at least one VCPU process according to a process identifier corresponding to the target VCPU process; and
select, through the virtual machine, the timer interrupt identifier corresponding to the target VCPU process from the interrupt identifiers respectively corresponding to the plurality of interrupt types comprised in the target attribute information.

10. The electronic device according to claim 8, wherein the processor is configured to, before modifying, through the virtual machine, the indication information corresponding to the timer interrupt identifier to the preset indication information:
perform a hook operation on a preset program within the virtual machine, wherein the hook operation is used to modify the indication information corresponding to the timer interrupt identifier to the preset indication information when the timer setting instruction is received.

11. The electronic device according to claim 10, wherein the preset program is a set next event function.

12. The electronic device according to claim 8, wherein a virtual machine control mode is provided in the CPU;
the processor is further configured to, before determining the target VCPU process corresponding to the timer setting instruction in response to receiving the timer setting instruction, and obtaining, through the virtual machine corresponding to the target VCPU process, the timer interrupt identifier corresponding to the target VCPU process:
modify the virtual machine control mode from a local timer mode to a virtual machine interrupt mode in response to the virtual machine switching from a host mode to the virtualization mode;
wherein the virtual machine interrupt mode is used by the CPU to send the timer interrupt information to the virtual machine running in the virtualization mode.

13. The electronic device according to claim 12, wherein the processor is further configured to:
modify the virtual machine control mode from the virtual machine interrupt mode to the local timer mode in response to the virtual machine switching from the virtualization mode to the host mode.

14. The electronic device according to claim 8, wherein the processor is further configured to, before determining the target VCPU process corresponding to the timer setting instruction in response to receiving the timer setting instruction, and obtaining, through the virtual machine corresponding to the target VCPU process, the timer interrupt identifier corresponding to the target VCPU process:
obtain a first quantity of timer interrupt information received by the virtual machine within a preset duration and a second quantity of other interrupt information, except the timer interrupt information, received by the virtual machine within the preset duration; and
if the first quantity is greater than the second quantity, perform the step of determining the target VCPU process corresponding to the timer setting instruction in response to receiving the timer setting instruction, and obtaining, through the virtual machine corresponding to the target VCPU process, the timer interrupt identifier corresponding to the target VCPU process.

15. A non-transitory computer-readable storage medium, wherein the computer-readable storage medium stores computer-execution instructions, and when a processor executes the computer-execution instructions, the following operations are performed, the operations being applied to a central processing unit (CPU), wherein the CPU comprises at least one physical central processing unit (PCPU), and the PCPU is configured to run a virtual central processing unit (VCPU) process on a virtual machine:
determining a target VCPU process corresponding to a timer setting instruction in response to receiving the timer setting instruction, and obtaining, through a virtual machine corresponding to the target VCPU process, a timer interrupt identifier corresponding to the target VCPU process;
modifying, through the virtual machine, indication information corresponding to the timer interrupt identifier to preset indication information, wherein the indication information is used to indicate whether the target VCPU process is capable of receiving timer interrupt information in a virtualization mode, and the preset indication information is used to indicate that the target VCPU process is capable of receiving the timer interrupt information in the virtualization mode; and
injecting timer interrupt information into the target VCPU process in the virtualization mode in response to set time corresponding to the timer setting instruction is up.

16. The non-transitory computer-readable storage medium according to claim 15, wherein the obtaining, through the virtual machine corresponding to the target VCPU process, the timer interrupt identifier corresponding to the target VCPU process comprises:
obtaining, through the virtual machine corresponding to the target VCPU process, attribute information respectively corresponding to at least one VCPU process within the virtual machine, wherein the attribute information comprises interrupt identifiers respectively corresponding to a plurality of interrupt types;
selecting, through the virtual machine, target attribute information corresponding to the target VCPU process from the attribute information respectively corresponding to the at least one VCPU process according to a process identifier corresponding to the target VCPU process; and
selecting, through the virtual machine, the timer interrupt identifier corresponding to the target VCPU process from the interrupt identifiers respectively corresponding to the plurality of interrupt types comprised in the target attribute information.

17. The non-transitory computer-readable storage medium according to claim 15, wherein before modifying, through the virtual machine, the indication information corresponding to the timer interrupt identifier to the preset indication information, the following operation is further performed:
performing a hook operation on a preset program within the virtual machine, wherein the hook operation is used to modify the indication information corresponding to the timer interrupt identifier to the preset indication information when the timer setting instruction is received.

18. The non-transitory computer-readable storage medium according to claim 17, wherein the preset program is a set next event function.

19. The non-transitory computer-readable storage medium according to claim 15, wherein a virtual machine control mode is provided in the CPU;
correspondingly, before determining the target VCPU process corresponding to the timer setting instruction in response to receiving the timer setting instruction, and obtaining, through the virtual machine corresponding to the target VCPU process, the timer interrupt identifier corresponding to the target VCPU process, the following operation is further performed:
modifying the virtual machine control mode from a local timer mode to a virtual machine interrupt mode in response to the virtual machine switching from a host mode to the virtualization mode;
wherein the virtual machine interrupt mode is used by the CPU to send the timer interrupt information to the virtual machine running in the virtualization mode.

20. The non-transitory computer-readable storage medium according to claim 19, wherein the following operation is further performed:
modifying the virtual machine control mode from the virtual machine interrupt mode to the local timer mode in response to the virtual machine switching from the virtualization mode to the host mode.
